(19) United States
(12) Patent Application Publication
(10) Pub. No.: US 2009/0143080 A1
(43) Pub. Date: Jun. 4, 2009

(54) Method, Subscriber Identity Module and System for Providing Mobile Communication Terminal Location Data

(76) Inventors: Steinar Brede, Trondheim (NO); Sune Jakobsson, Hommelvik (NO)

Correspondence Address: BIRCH STEWART KOLASCH & BIRCH, PO BOX 747, FALLS CHURCH, VA, 22040-0747, US

(21) Appl. No.: 12/086,416

(22) PCT Filed: Nov. 17, 2006
(86) PCT No.: PCT/NO2006/000420

§ 371 Date: Jun. 12, 2008

(30) Foreign Application Priority Data
Dec. 12, 2005 (NO) 2005 5897

(51) Int. Cl. H04W 4/02

(52) U.S. Cl. 455/456.6

(57) ABSTRACT

The invention relates to a method for providing mobile communication terminal location data. In the method, radio signal is received from a beacon in a wireless local area network. Next, beacon identification data that identifies the beacon is derived, based on the received radio signal. The identification data is transmitted to a server. Beacon location data is then provided by and received from the server. Mobile communication terminal location data, particularly presence data that indicates that the mobile communication terminal is in the vicinity of the beacon, is derived from the beacon location data. Upon such detected presence, an additional application process is advantageously executed. The method is executed by a processing device in a subscriber identity module that is included in the mobile communication terminal, thus achieving hidden operation and portability. The invention also relates to a subscriber identity module and a system operating in accordance with the method.

### TECHNICAL FIELD

The present invention relates in general to mobile and wireless communication technology.

More specifically, the invention relates to a method for providing mobile communication terminal location data. The invention also relates to a subscriber identity module which includes a processing device that is configured for executing such a method. Finally, the invention relates to a system wherein the method is used.

### BACKGROUND OF THE INVENTION

Many approaches have previously been suggested for the problem of locating or detecting the presence of mobile communication terminals operating in wireless communication systems. Such prior art approaches include cell-based methods for cellular systems (i.a., cell of origin and, time of arrival methods) and GPS-based methods.

A recent, alternative approach for localizing a mobile communication terminal is known as the Place Lab system, suggested by Intel Corp., described in Technology@Intel Magazine, October 2005 (http://www.intel.com/technology/magazine/researchlplace-lab-1005.pdf). In this system, a mobile communication terminal, such as a WLAN-enabled PDA, is arranged to localize itself by listening for WLAN access points. The mobile communication terminal derives identification data, such as the MAC address, of each radio beacon, looks up the associated beacon's position in a database, and estimates its own position, referenced to the positions of the beacons. The Place Lab system relies on pre-registered position data of the WLAN access points, recorded during an error prone registration process.

Disadvantages of the Place Lab system are that it involves extensive user interaction and low degree of portability. Further, it is not particularly suitable for determining the location of regular mobile telephones, which are generally not equipped with means for WLAN communication. Also, the Place lab system lacks quality assurance of the pre-registered location information. It also lacks inherent mechanisms for privacy control.

A subscriber identity module, or SIM card, is a removable smart card module for use with mobile communication terminals, such as GSM mobile telephones. The SIM card contains subscriber specific data and is, in use, operatively accessible by the central processing unit of the mobile terminal. The SIM card typically also comprises features for authenticating a user/subscriber. The SIM card includes a processing unit, a memory device and I/O devices for communication with the processing unit of the mobile terminal. The memory device contains a subscriber authentication key and computer program instructions for causing the SIM card processing unit to authenticate the user/subscriber.

WO-2005/096651 relates to a subscriber identity module for a mobile communication terminal, the module including an interrogatable RFID transponder which is operatively controllable by the processing device in the subscriber identity module. The subscriber identification module may be used as an authentication token, i.e. for a access control system.

### SUMMARY OF THE INVENTION

An objective of the present invention is to provide a method, a subscriber identification module and a system for providing mobile communication terminal location data.

In accordance with the present invention there is provided a method, a device and a system as set forth in the appended independent claims.

Further advantageous embodiments of the invention are set forth in the dependent claims.

A feature of the present invention is that the method is executed by the processing device included in the subscriber identity module, rather than by any other processing device included in the mobile communication terminal. This feature implies that several major advantages are achieved. Firstly, the entire process may be hidden to the user of the mobile communication terminal, and consequently, unnecessary or undesired user interaction may be reduced or eliminated. Secondly, portability is achieved, i.e. the services provided by the method will follow the user's mobile communication subscription when changing from one physical mobile communication terminal to another. Thirdly, strong mechanisms for privacy control are achieved.

Additional features and principles of the present invention will be recognized from the detailed description below.

It is to be understood that both the foregoing general description and the following detailed description are exemplary and explanatory only and are not restrictive of the invention as claimed.

### BRIEF DESCRIPTION OF THE DRAWINGS

The accompanying drawings illustrate a preferred embodiment of the invention. In the drawings,

FIG. 1 is a schematic block diagram illustrating a system according to the invention,

FIG. 2 is a schematic flowchart illustrating a method according to a first embodiment of the invention,

FIG. 3 is a schematic flowchart illustrating a method according to a second embodiment of the invention, and

FIG. 4 is a schematic block diagram illustrating a subscriber identity module in accordance with the invention

### DETAILED DESCRIPTION OF THE INVENTION

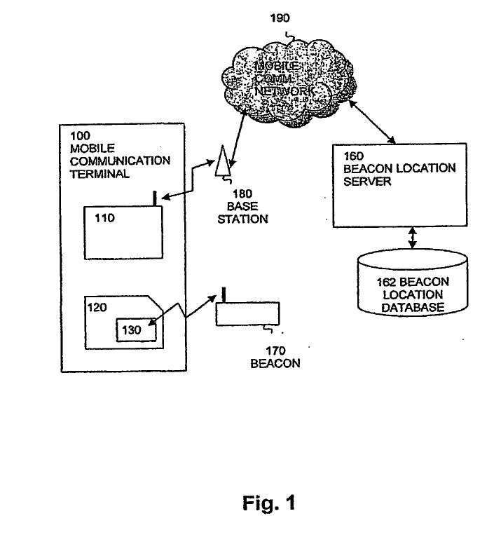

FIG. 1 is a schematic block diagram illustrating a system according to the invention.

A mobile communication terminal 100 comprises a mobile communication module 110 operatively connected to a mobile communication antenna. The mobile communication module 110 and the antenna enable the mobile communication terminal 100 to communicate with a base station 180 in a mobile communication network 190.

The mobile communication module 110 is typically a GSM/GPRS enabled mobile communication module. Thus, the mobile communication terminal 100 may be a GSM/GPRS enabled mobile telephone, a PDA, a palmtop/notebook computer, or the like. Correspondingly, the base station 180 is typically a GSM/GPRS enabled base station and the mobile communication network 190 is typically a GSM/GPRS enabled mobile communication network.

A beacon location server 160 is operatively connected to the mobile communication network 190. The server 160 is further operatively connected to a beacon location database or at least a data storage 162, which contains information on at least one beacon, and preferably several beacons, identified by their identification data (such as MAC addresses) and location data associated with each beacon identification data.

The beacon location server 160 is arranged for receiving a beacon location request from a mobile communication terminal operating in the mobile communication network, e.g. by a message such as an SMS or a hidden SMS.

Alternatively, the beacon location request is received as a request command transmitted by a GPRS connection.

The server is further arranged to derive beacon identification data from the request, and to look up in the database or data storage 162 the location data that is associated with the beacon identification data. Finally, the server is arranged for transmitting the location data back to the requesting mobile communication terminal, e.g. by means of a message (SMS, hidden SMS).

Alternatively the server is arranged for transmitting the location data back to the requesting mobile communication terminal by means of a GPRS connection.

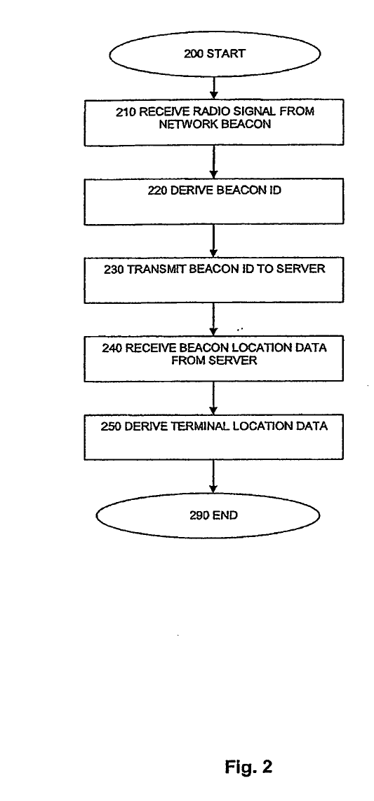

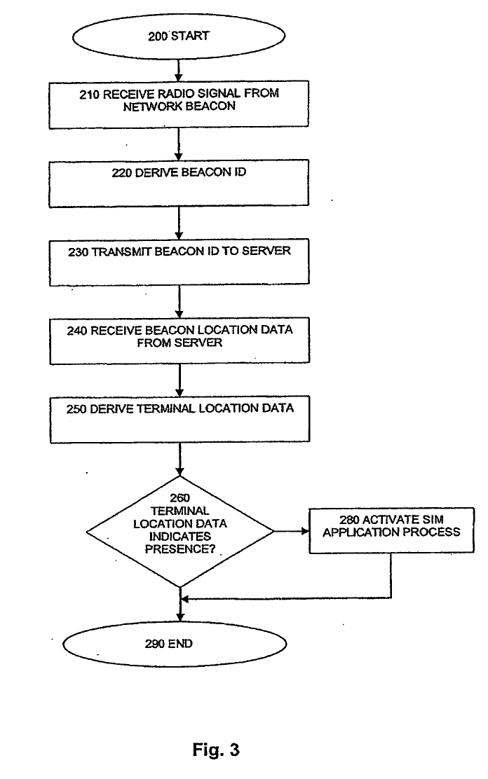

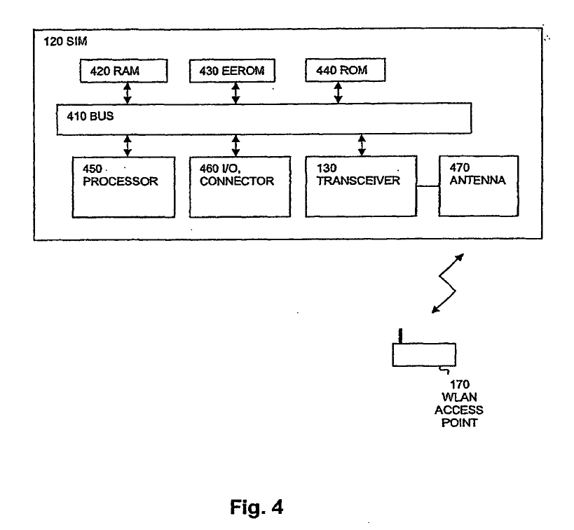

The mobile communication terminal 100 also comprises a subscriber identity module (SIM) 120 which includes a processing device (see also FIG. 4), which in turn is configured to operate according to the present invention, particularly according to a method as disclosed with reference to one of the FIG. 2 or 3 below.

The SIM 120 further comprises a radio transceiver 130, operatively connected to an antenna (cf. also FIG. 4). The antenna and the transceiver 130 are arranged to operate in conjunction with the beacon 170 in a wireless local area network. More specifically, the beacon 170 is advantageously a WLAN (IEEE 802.11x) access point, and the radio transceiver 130 is advantageously a WLAN (IEEE 802.11x) transceiver.

The SIM 120 is further described with reference to FIG. 4 below.

Although only the mobile communication module 110 and the SIM 120 are specifically shown in FIG. 1, the skilled person will readily realize that the mobile communication terminal 100 also includes other regular components of a mobile communication terminal, such as a processor, a memory, a keyboard, a display, an audio module which includes a microphone and a speaker, etc. Although not expressly illustrated in FIG. 1, the mobile communication module 110 and the SIM 120 are operatively interconnected.

FIG. 2 is a schematic flowchart illustrating a method according to a first embodiment of the invention.

Basically, the flowchart shows a method for providing mobile communication terminal location data. The steps of the method are executed by a processing device in a subscriber identity module which is included in the mobile communication terminal. For the purpose of illustration, the method is described for use in the system illustrated in FIG. 1, i.e. the method is performed by the processing device in the SIM 120 in the mobile communication terminal 100.

The method starts at the initial step 200. The method is initiated by a user operation or by receiving an activating signal through the mobile communication network.

First in the method, the processing device in the subscriber identity module 120 performs the beacon signal receiving step 210, wherein a radio signal is received from the beacon 170 in a wireless local area network. In the preferred embodiment, the beacon 170 is a IEEE 802.11 (Wi-Fi) WLAN access point, i.e. a wireless networks device that connects wireless communication and computer devices together in order to provide a wireless local area network. In particular, the radio signal is received by means of an antenna included in the subscriber identity module.

Next, in the identification data deriving step 220, identification data that identifies the beacon 170 is derived, based on the received radio signal. Advantageously, the identification data is a MAC address associated with the beacon, and which is included in, and derivable from, the radio signal transmitted by the beacon 170. A MAC address (Media Access Control address) is a unique identifier associated with a wireless network device, e.g. as prescribed by the IEEE 802.11 specification.

Advantageously, additional data is also derived from the received radio signal. The additional data advantageously comprises the signal strength of the signal received from the beacon 170.

Typically, a plurality of signals are received from various beacons 170 at the same time. The signal strength is then advantageously used for selecting the most pronounced beacon 170 as the most relevant candidate for estimating the position of the mobile communication terminal.

Alternatively, when signal strength is derived from signals from three or more distinct beacons, the signal strength values are used for estimating the position of the mobile communication terminal more accurately, by using weighted triangulation approach based on the signal strength values. The calculations necessary to obtain this position estimate are advantageously performed in the SIM processor, or alternatively by a central processing unit in a server.

Next, in the identification data transmitting step 230, the identification data is transmitted to the server 160.

Advantageously, the mobile communication module 110 included in the mobile communication terminal is used in the transmitting step 230. More specifically, the identification data is transmitted by means of a message, such as an SMS or more preferably a hidden SMS, or alternatively as a request command transmitted by a GPRS connection through the mobile communication network 190.

As explained with reference to FIG. 1 above, the server 160 is arranged for providing beacon location data, based on the beacon identification data, and for transmitting such data back to the requesting mobile communication terminal.

Next, in the location data receiving step 240, beacon location data that represents the location of the beacon 170 is received from the server 160.

Next, in the terminal location data deriving step 250, mobile communication terminal location data is derived, based on the beacon location data.

Advantageously, the calculations necessary in this location deriving step are performed by a processor embedded on the SIM module, particularly the SIM processor 450 (cf. FIG. 4). Alternatively, the calculations are performed by an external server.

If an external server is used, or if the SIM processor allows for more resource demanding computing capabilities, more sophisticated and methods may be used for enhancing the location deriving step. Such methods include the use of map databases, Kalman filtering, calculations involving historical data, etc.

Advantageously, the step 250 of deriving the mobile communication terminal location data based on the beacon location data comprises deriving presence data that indicates that the mobile communication terminal is in the vicinity of the beacon 170.

In order to determine such presence, at least two methods may be applied:

Advantageously, a centrally performed application, e.g. on a server, activates a position “sniffing” on the SIM. The SIM responds by submitting its position (e.g., in terms of detected WLAN MAC addresses) to the requesting server. The server will then compute actual positions and determine the corresponding acts to be performed.

Alternatively, a central application, e.g. on a server, activates a position “sniffing” on the SIM card. The server also transfers data that indicates one or more positions (e.g., in terms of corresponding WLAN MAC addresses), to which the SIM shall respond.

The process illustrated in FIG. 2 terminates at the terminating step 290.

FIG. 3 is a schematic flowchart illustrating a method according to a second embodiment of the invention.

The process illustrated in FIG. 3 mainly corresponds to the process illustrated in FIG. 2.

However, in the second embodiment illustrated in FIG. 3, the terminal location data deriving step 250 is followed by the presence test step 260, wherein it is determined if the presence data derived in step 250 indicates that the mobile communication terminal 100 is in the vicinity of the beacon 170 in the wireless local area network.

If this test is not true, the process continues at the terminating step 290.

If the test is true, the process continues at the application activating process 280, wherein an additional application process is activated for execution by the processing device in the subscriber identity module.

The additional application process may, e.g., be a process included in a guiding or information service. For instance, if the system according to the invention is used in museum premises, various attractions in the museum may be associated with WLAN beacons each arranged at the respective attractions. A mobile communication terminal with a SIM card in accordance with the invention may be operated by a museum visitor. The mobile communication terminal will then be able to detect its presence to each beacon, and this detected presence will in turn trigger a guiding application in the mobile communication terminal, providing further information to the museum visitor. Since the method is performed by the subscriber identity module, most of the process may be hidden to the museum visitor, except from the presentation of relevant information about the museum attraction.

Next, the process continues at the terminating step 290.

FIG. 4 is a schematic block diagram illustrating a subscriber identity module in accordance with the invention.

The subscriber identity module (SIM) 120 is implemented as a smart card, comprising an internal bus 410 which interconnects a processor 450, memory circuits 420, 430, 440, an input/output circuit 460, and a transceiver 130.

The radio transceiver 130 is operatively connected to the antenna 470, which is included in the SIM card 120. The transceiver 130 and the antenna 470 are arranged to operate in conjunction with a WLAN beacon 170. To this end, the transceiver 130 and the antenna 170 are advantageously arranged to transmit and receive in accordance with the WLAN (IEEE 802.11x) specification.

The memory circuits typically comprise a volatile memory 420 such as a RAM, a semi-volatile memory 430 such as a Flash memory or an EEPROM, and a non-volatile memory 440 such as a ROM. The input/output circuit 460 comprises an electrical connection to the remaining components of the mobile communication terminal 100 (cf. FIG. 1).

Advantageously, the hardware configuration of the SIM is implemented in accordance with the UICC specification, i.e. as a 25×15 mm card for insertion into a standardized slot in a mobile communication terminal. The SIM cars's compliance with a standard specification enables a subscriber easily to move his/her mobile telephone subscription, and the corresponding telephone number, from one mobile communication terminal to another.

The memory, in particular the non-volatile memory 440 and/or the semi-volatile memory 430, includes processor instructions which form a logical application for execution by the processor 450. In particular, the processor instructions are configured to enable the SIM to perform a method according to the present invention, e.g., a method as disclosed above with reference to FIG. 2 or FIG. 3.

In addition, processor instructions contained in the SIM memories provide regular SIM functions, i.e. functions for secure storage of subscription information, storage of configuration data (e.g., preferences), storage of text messages, etc.

The invention has been described above with reference to museum guiding as an exemplary use. The skilled person will realize that many other use areas are possible, such as a payment application, wherein a payment transaction may be triggered upon the detection of a certain position of the mobile communication terminal, e.g. when the mobile communication terminal is determined to be located in the vicinity of a point of sale terminal, such as a cash register.

Another, particular scenario for use of the invention is an emergency situation, wherein beacon location data may be automatically acquired by the mobile communication terminal and forwarded to an adequate addressee in the case of an emergency call from the mobile communication terminal 100.

The above detailed description has explained the invention by way of example. A person skilled in the art will realize that numerous variations and alternatives to the detailed embodiment exist within the scope of the invention, as set forth by the appended claims.

For instance, the basic features of the invention could also be achieved by replacing the transceiver 130 in the SIM by a receiver, i.e. a transceiver without transmitting capabilities.

Moreover, although the transceiver 130 in the SIM has been specified as a IEEE 802.11 WLAN transceiver and the beacon 170 has accordingly been specified as a corresponding WLAN access point, the skilled person will readily realize that the invention could also be implemented using wireless communication at other frequencies or with different protocols, such as radio communication in accordance with the Bluetooth specification.

The SIM module has been illustrated as including one processing unit. It should be appreciated that a multiprocessor approach is also possible within the concept of the invention.

1-15. (canceled)

16. A communication method for providing mobile communication terminal location data for a mobile communication terminal, the communication method comprising:
receiving a radio signal from a beacon in a wireless local area network;
deriving beacon identification data identifying the beacon, based on the received radio signal;
transmitting the identification data to a server;
receiving, from the server, beacon location data representing the location of the beacon; and
deriving the mobile communication terminal location data, based on the beacon location data.

17. The communication method according to claim 16, wherein receiving the radio signal from the beacon includes the use of an antenna included in a subscriber identity module, where the subscriber identity module is included in the mobile communication terminal.

18. The communication method according to claim 16, wherein transmitting the identification data to the server includes operating a mobile communication module included in the mobile communication terminal.

19. The communication method according to claim 16, wherein deriving the mobile communication terminal location data based on the beacon location data includes deriving presence data that indicates that the mobile communication terminal is in the vicinity of the beacon in the wireless local area network.

20. The communication method according to claim 18, wherein deriving the mobile communication terminal location data based on the beacon location data includes deriving presence data that indicates that the mobile communication terminal is in the vicinity of the beacon in the wireless local area network.

21. The communication method according to claim 16, further comprising:
activating an additional application process by the subscriber identity module when the presence data indicates that the mobile communication terminal is in the vicinity of the beacon in the wireless local area network.

22. The communication method according to claim 19, further comprising:
activating an additional application process by the subscriber identity module when the presence data indicates that the mobile communication terminal is in the vicinity of the beacon in the wireless local area network.

23. The communication method according to claim 20, further comprising:
activating an additional application process by the subscriber identity module when the presence data indicates that the mobile communication terminal is in the vicinity of the beacon in the wireless local area network.

24. A communication system for providing mobile communication terminal location data, the communication system comprising:
a mobile communication network, including a base station;
a wireless local area network, including a beacon;
a server, operatively connected to the mobile communication network, arranged for providing beacon location data based on a request including beacon identification data; and
a mobile communication terminal which includes
a mobile communication module arranged to communicate with the base station in the mobile communication network, and
a subscriber identity module, the subscriber identity module comprising a processing device,
wherein the processing device in the subscriber identity module
receiving a radio signal from the beacon in the wireless local area network,
deriving beacon identification data identifying the beacon, based on the received radio signal,
transmitting the identification data to the server,
receiving from the server beacon location data representing the location of the beacon, and
deriving the mobile communication terminal location data, based on the beacon location data.

25. The communication system according to claim 24, wherein the processing device receives the radio signal from the beacon by using an antenna included in the subscriber identity module.

26. The communication system according to claim 24, wherein transmitting the identification data to the server includes operating a mobile communication module included in the mobile communication terminal.

27. The communication system according to claim 24, wherein deriving the mobile communication terminal location data based on the beacon location data includes deriving presence data that indicates that the mobile communication terminal is in the vicinity of the beacon in the wireless local area network.

28. The communication system according to claim 26, wherein deriving the mobile communication terminal location data based on the beacon location data includes deriving presence data that indicates that the mobile communication terminal is in the vicinity of the beacon in the wireless local area network.

29. The communication system according to claim 24, wherein the processing device activating an additional application process by the subscriber identity module when the presence data indicates that the mobile communication terminal is in the vicinity of the beacon in the wireless local area network.

30. The communication system according to claim 27, wherein the processing device activating an additional application process by the subscriber identity module when the presence data indicates that the mobile communication terminal is in the vicinity of the beacon in the wireless local area network.

31. The communication system according to claim 28, wherein the processing device activating an additional application process by the subscriber identity module when the presence data indicates that the mobile communication terminal is in the vicinity of the beacon in the wireless local area network.

32. A machine-readable medium having instructions stored thereon, such that when the instructions are read and executed by a processor, the processor is configured to perform the steps of:
receiving a radio signal from a beacon in a wireless local area network;
deriving beacon identification data identifying the beacon, based on the received radio signal;
transmitting the identification data to a server;
receiving, from the server, beacon location data representing the location of the beacon; and
deriving the mobile communication terminal location data, based on the beacon location data.
